(19) United States
(12) Patent Application Publication
(10) Pub. No.: US 2026/0043433 A1
(43) Pub. Date: Feb. 12, 2026

(54) CONNECTOR DEVICE FOR INTERCONNECTING MULTIPLE OBJECTS

(71) Applicant: Jonathan Harold Jones, Manvel, TX (US)

(72) Inventor: Jonathan Harold Jones, Manvel, TX (US)

(21) Appl. No.: 18/895,371

(22) Filed: Sep. 24, 2024

Related U.S. Application Data
(60) Provisional application No. 63/682,060, filed on Aug. 12, 2024.

(51) Int. Cl. F16B 37/08; F16B 37/06; F16B 39/06; F16B 41/00

(52) U.S. Cl. CPC F16B 37/0842; F16B 37/061; F16B 37/0857; F16B 39/06; F16B 41/002

(57) ABSTRACT

Disclosed is a connector device for connecting a first object and a second object. The connector device is disposed on the first object. The connector device comprises a bracket member. The bracket member comprises a first surface, a second surface parallel to the first surface and a connecting surface connecting the first surface and the second surface. The connector device further comprises a female member disposed on the first surface and a receptacle disposed on the second surface. The receptacle receives a male member. The male member is received through the receptacle, an opening in the second object and into the female member to connect the first object with the second object.

### TECHNICAL FIELD

The present disclosure generally relates to mechanical connectors. Specifically, the present disclosure relates to a connector device for interconnecting multiple objects.

### BACKGROUND

Generally, mechanical connectors have played a significant role in a variety of engineering fields including mechanical engineering, civil engineering, aeronautical engineering, automobile engineering and the like. Such mechanical connectors have been employed for permanently or detachably attaching multiple components of an object or separate objects to each other. Such an attachment usually comprises placing both the objects to be attached to be in direct contact with each other and employing the mechanical connector to connect attach the objects, such as, by passing a member of the mechanical connector through receptacles in both the objects and subsequently, locking the member in place.

However, such an operation of employing the mechanical connector for attaching the objects is associated with numerous drawbacks. For example, the connector of the mechanical connector through multiple objects requires precise alignment of receptacles formed in all the objects for receiving the member of the mechanical connector that passes through the objects. An imperfect alignment of the receptacles and/or the mechanical connector with the objects leads to imperfect attachment of the objects, which may cause unexpected detachment and thus, endanger safety of people and/or property nearby. Additionally, when the mechanical connectors are employed for detachable attachment of the objects, the mechanical connector employed for attaching may have to be destructively removed, thereby, causing wastage of resources.

In light of the above discussion, it can be readily recognized that there exists an urgent need for improved mechanical connectors that can be conveniently employed for detachable or permanent attachment of multiple objects.

### SUMMARY

The present disclosure provides a connector device for connecting a first object and a second object. The connector device is disposed on the first object. The connector device comprises a bracket member comprising a first surface, a second surface parallel to the first surface and a connecting surface connecting the first surface and the second surface. The connector device further comprises a female member disposed on the first surface and a receptacle disposed on the second surface. The receptacle receives a male member. The male member is received through the receptacle, an opening in the second object and into the female member to connect the first object with the second object.

The disclosed connector device offers an efficient and secure tool for alignment and attachment of the first object and second object by ensuring accurate and reliable connections therebetween. Consequently, the connector device reduces time and effort required for installation while minimizing safety hazards associated with misalignment between the first object and the second object, thus, offering a secure and streamlined connection.

In an embodiment, the bracket member is one of: a C-bracket, a D-bracket, a G-bracket, a H-bracket, a U-bracket. Such a variety of bracket member configurations enables versatile adaptation of the connector device for different geometric requirements and application environments.

In another embodiment, the connecting surface is selected from: a curved surface, an angled surface comprising at least one bent portion. The inclusion of different possibilities of shapes of the connecting surface provides improved adaptability to non-flat or irregular object surfaces. The variation further facilitates better contact, improves load distribution and enhances the stability and reliability of the connection.

In yet another embodiment, the female member is one of: a nut, a hollow shaft comprising internal threads, a shaft collar, a hinge collar, a threaded split collar, a clamp, a U-clip, a spring-loaded shaft collar, a socket comprising internal threads, a clamping ring, a snap-fit receiver, a detent mechanism receiver. Such a diversity in the selection of the female member ensures compatibility with different male members, thereby enhancing versatility and functionality of the connector device across various fields.

In still another embodiment, the male member is one of: a bolt, a screw, a shaft comprising external threads, a pin, a rod, a dowel, a snap-fit component to be received into the snap-fit receiver, a detent pin to be received into the detent mechanism receiver. Such possible variations of the male member enable accommodation of the connector device for different design requirements, thereby enhancing an ability of the connector device to handle a wide range of mechanical stresses and operational conditions.

In a further embodiment, the female member is detachably disposed on the first surface and the male member is removably received into the receptacle. The detachability of the female member and the removability of the male member from the mechanical connector enable easy assembly and disassembly of the connector device. Consequently, reusability of the connector device in different applications is improved and resource wastage is reduced.

In another embodiment, the male member is spring-loaded. The spring-loading of the male member enables automatic engagement and alignment of the male member with the female member, thereby ensuring consistent and reliable connection under varying conditions

In yet another embodiment, the spring-loaded male member is biased towards the first surface. Such biasing of the spring-loaded male member towards the first surface reduces effort required to be exerted by a user for inserting the male member into the female member and therefore, to connect the first object with the second object.

In still another embodiment, the female member comprises a quick-release mechanism. The incorporation of the quick-release mechanism in the female member allows rapid and convenient disconnection, further improving operational efficiency of the connector device. Consequently, the quick-release mechanism improves usage of the connector device in applications that require frequent reconfiguration or maintenance.

In a further embodiment, the male member comprises a stopper component. Further, a surface area of the stopper component is more than a size of the receptacle. Such a stopper component having the surface area larger than the size of the receptacle prevents inadvertent disengagement of the male member from the receptacle. Consequently, the stopper component functions as a fail-safe by ensuring a robust and stable connection of the male member with the bracket member.

In another embodiment, the stopper component comprises a non-rotating nut and a plate disposed at a predefined separation from the non-rotating nut. Each of a first surface area of the non-rotating nut and a second surface area of the plate is more than the size of the receptacle.

In yet another embodiment, the connecting surface comprises an orifice for receiving a first end of a cable therein and a second end of the cable is received in the separation between the non-rotating nut and the plate.

In still another embodiment, a nut is welded onto a rear side of the first surface.

In a further embodiment, a helical spring is disposed between a rear side of the second surface and the plate. The helical spring is biased away from the rear side of the second surface.

### BRIEF DESCRIPTION OF DRAWINGS

Notwithstanding any other forms which may fall within the scope of the present invention, preferred embodiments of the disclosure will now be described, by way of example only, with reference to the accompanying drawings in which: to the drawings, in which:

FIG. 1 shows a left-hand side perspective view of a bracket member of a connector device (shown in FIG. 2), in accordance with an embodiment of the present disclosure;

FIG. 2 shows a left-hand side perspective view of a connector device, in accordance with an embodiment of the present disclosure;

FIG. 3 shows a left-hand side perspective view of the connector device of FIG. 2, in accordance with another embodiment of the present disclosure;

FIG. 4 shows a left-hand side perspective view of the connector device of FIGS. 2-3, in accordance with yet another embodiment of the present disclosure;

FIG. 5 shows a side view of the male member (shown in FIG. 2), in accordance with an embodiment of the present disclosure;

FIG. 6 shows a top view of the bracket member (shown in FIG. 1), in accordance with an embodiment of the present disclosure;

FIG. 7 shows a left-hand side perspective view of the connector device, in accordance with an embodiment of the present disclosure;

FIG. 8 shows a left-hand side perspective view of the connector device (shown in FIG. 7), in accordance with an embodiment of the present disclosure;

FIG. 9 shows a right-hand side perspective view of the connector device (shown in FIG. 8), in accordance with an embodiment of the present disclosure;

FIG. 10 shows a bottom-side view of the connector device (shown in FIG. 9), in accordance with an embodiment of the present disclosure; and

FIG. 11 shows a right-hand side perspective view of the connector device (shown in FIGS. 9-10), in accordance with an embodiment of the present disclosure.

### DETAILED DESCRIPTION OF DRAWINGS

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

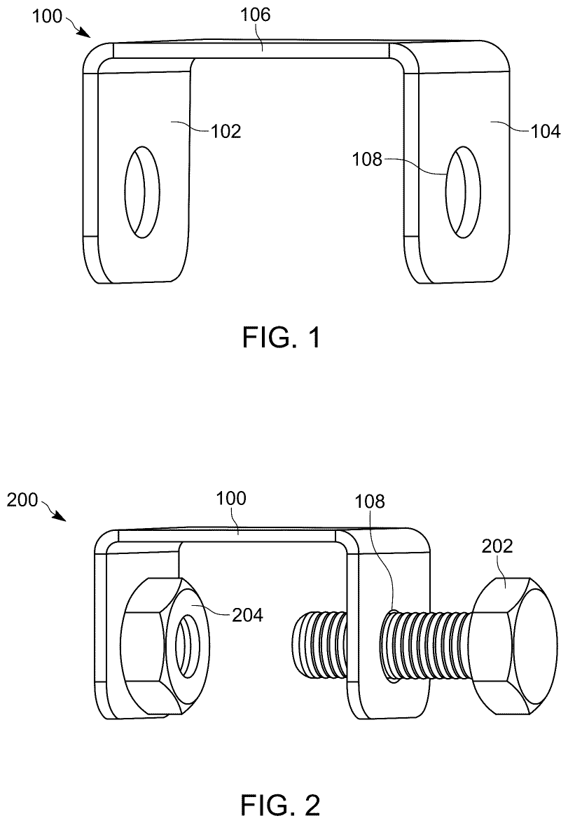

FIG. 1 shows a left-hand side perspective view of a bracket member 100 of a connector device 200 (shown in FIG. 2), in accordance with an embodiment of the present disclosure. The bracket member 100 comprises a first surface 102, a second surface 104 parallel to the first surface 102 and a connecting surface 106 connecting the first surface 102 and the second surface 104. As shown, the bracket member 100 comprises the first surface 102, which is a planar member disposed on a first extremity of the bracket member 100. The bracket member 100 further comprises the second planar surface 104, which is another planar member disposed on a second extremity of the bracket member 100. Further, the first surface 102 and the second surface are parallel to each another. Such a parallel alignment of the first surface 102 and the second surface 104 enables accurate alignment between a member received on the first surface 102 and another member received on the second surface 104.

Moreover, a receptacle 108 is disposed on the second surface 104. The receptacle 108 is implemented as an opening that is formed into the second surface 104, such as, through removal of material from the second surface 104. It will be appreciated that a shape and dimensions of the receptacle can be selected based on specific requirements of application of the connector device 200. For example, the receptacle 108 can have a circular shape, an ovular shape, a square shape, a triangular shape and the like.

As shown, the first surface 102 and the second surface 104 are interconnected by the connecting surface 106. The connecting surface 106 is an elongate surface that is disposed perpendicularly to each of the first surface 102 and the second surface 104. It will be appreciated that the first surface 102, the second surface 104 and the connecting surface 104 can be formed as a single unified component or as separate components that are joined together, such as, by welding them together. which extends between and joins the first and second surfaces.

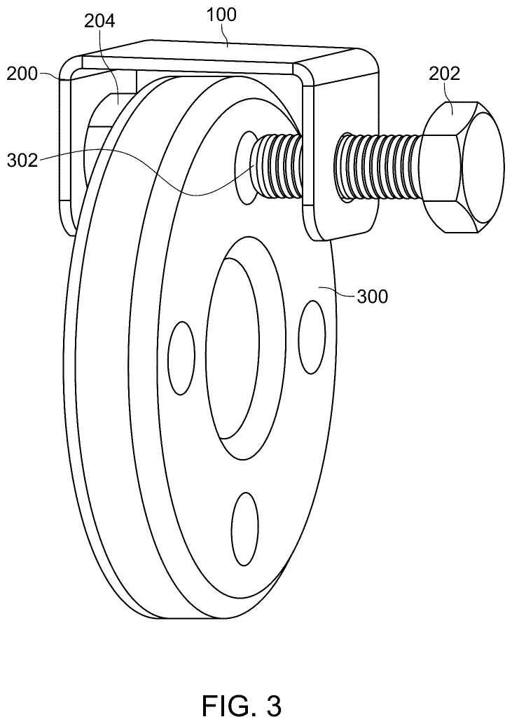

FIG. 2 shows a left-hand side perspective view of a connector device 200, in accordance with an embodiment of the present disclosure. The connector device 200 comprises the bracket member 100 (shown in FIG. 1), a male member 202 to be received through the receptacle 108 and a female member 204 disposed on the first surface 104. The male member 202 is received through the receptacle 108, an opening in a second object (shown in FIG. 3) and into the female member 204 to connect a first object (not shown) with the second object. As shown, the male member 202 is an elongate component that is received through the opening formed by the receptacle 108 in the second surface 104.

Further, the female member 204 is a component that is disposed on the first surface 102 such that the female member 204 receives the elongate male member 202 therein. Such receiving of the male member 202 into the female member 204 enables accurate alignment of the male member 202, the second object through which the male member 202 is received and the female member 204 such that during operation of the connector device 200, relative movement is prevented between the first object on which the bracket member 100 is disposed and the second object that is connected to the first object by passing the male member 202 therethrough. Consequently, the first object and the second object are maintained in an immovable and secure state with respect to each other through operation of the connector device 200.

Optionally, the male member 202 is welded after receiving the male member 202 into the female member 204 to enable permanent connection of the first object with the second object. Alternatively, the male member 202 is removably received into the female member 204 such that the first object is decoupled from the second object through removal of the male member 202 from the female member 204.

In one embodiment, each of the bracket member 100, the male member 202 and the female member 204 are fabricated from a same material selected from a group comprising, but not limited to, stainless steel, aluminum, steel or plastic. Alternatively, each of the bracket member 100, the male member 202 and the female member 204 are fabricated from different materials. Optionally, the connector device 200 is coated with a finishing material, such as, by galvanizing with zinc, coating with polytetrafluoroethylene, nickel and the like, anodizing, electroplating with chrome and so forth, to meet mission-critical demands.

In one example, the connector device 200 is employed in automobile manufacturing to align and secure components such as engine mounts, transmission brackets and subframe connectors of the vehicle. In such an example, the connector device 200 ensures precise fit and structural integrity of such critical components within a chassis of the vehicle.

In another example, the connector device 200 is employed in civil construction to attach structural elements such as pre-fabricated steel beams and reinforced concrete columns, as well as steel trusses and masonry walls. In such an example, the connector device 200 enables accurate assembly and provides stability to overall framework of the building, ensuring that a structural load associated therewith is evenly distributed and the construction is robust.

FIG. 3 shows a left-hand side perspective view of the connector device 200 of FIG. 2, in accordance with another embodiment of the present disclosure. The connector device 200 is disposed on a first object (now shown). Further, the second object 300 to be connected to the first object is received within the connector device 200, such as, between the male member 202 and the female member 204. Subsequently, the opening 302 in the second object 300 that is to receive the male member 202 therein is aligned with the male member 202.

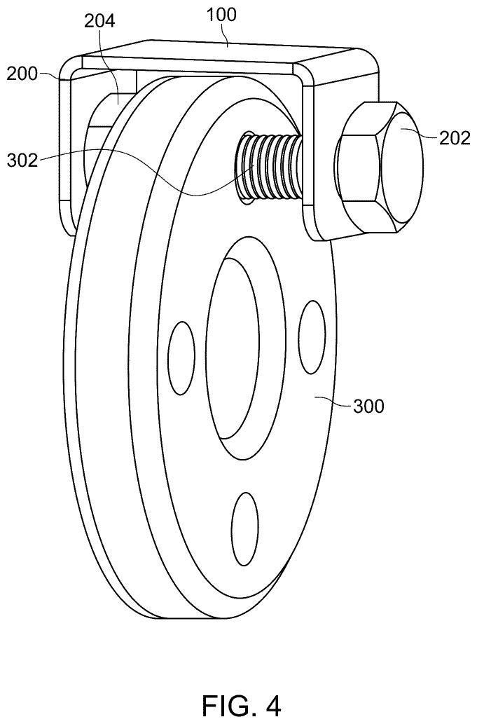

FIG. 4 shows a left-hand side perspective view of the connector device 200 of FIGS. 2-3, in accordance with yet another embodiment of the present disclosure. As shown, the male member 202 is passed completely through the opening 302 in the second object 300 and subsequently received into the female member 204. Thereafter, the male member 202 is secured with the female member 204, such as, by rotating, welding, hammering and the like, to connect the first object with the second object 300 using the connector device 200.

The connector device 200 can be fabricated in a variety of sizes based on application requirements thereof, without departing from a scope of the present disclosure. In an example, the connector device 200 is fabricated to be 0.5 inches long. In another example, the connector device 200 is fabricated to be 36 inches long.

In an embodiment, the bracket member 100 is a C-bracket, a D-bracket, a G-bracket, a H-bracket, or a U-bracket. Such a variety of bracket member configurations enables versatile adaptation of the connector device 200 to different geometric requirements and application environments. For example, a C-bracket can be employed for securing lightweight panels in a manufacturing setup. In another example, a U-bracket can be employed to support structural components in construction. Such an availability of different shapes of the bracket member 100 ensures that the connector device 200 can be customized to fit various structural designs and operational needs, providing flexibility in application, allowing the connector device 200 to accommodate diverse structural and functional requirements and thus, improving utility and adaptability of the connector device 200 for different applications.

In another embodiment, the connecting surface 106 is a curved surface or an angled surface comprising at least one bent portion. The inclusion of the different shapes for the connecting surface 106 enhances adaptability of the connector device 200 to non-flat or irregular object surfaces. For example, a curved surface can be used to create a conforming connection with cylindrical components. In another example, an angled surface with bent portions enables improved connections in angular or constrained spaces. Such variation in the shape of the connecting surface 106 allows the connector device 200 to effectively engage with diverse and irregular surfaces, thereby improving the stability and reliability of connection in complex environments by improving contact, load distribution and overall stability of the connection.

In yet another embodiment, the female member 204 is a nut, a hollow shaft comprising internal threads, a shaft collar, a hinge collar, a threaded split collar, a clamp, a U-clip, a spring-loaded shaft collar, a socket comprising internal threads, a clamping ring, a snap-fit receiver, or a detent mechanism receiver. Such a diversity in the selection of the female member 204 ensures compatibility with various male members 202, enhancing versatility and functionality of the connector device 200. For example, a snap-fit receiver can be used in applications requiring quick assembly and disassembly. In another example, a threaded split collar is employed in heavy-duty applications requiring secure and adjustable connections. Such availability of options for the female member 204 improves suitability of the connector device 200 for a wide variety of applications, improving effectiveness thereof across different operational requirements.

In still another embodiment, the male member 202 is a bolt, a screw, a shaft comprising external threads, a pin, a rod, a dowel, a snap-fit component to be received into the snap-fit receiver, or a detent pin to be received into the detent mechanism receiver. Such variations in the male member allow the connector device 200 to be adapted to different design specifications and requirements. For example, a bolt or screw can be used for secure, high-torque connections in structural applications. In another example, a snap-fit component or detent pin can be employed for applications that require quick and tool-free engagement. Such a variety in configurations for the male member 202 improves adaptability of the connector device 200 to various design needs and operational environments, improving capability of the connector device 200 to handle diverse mechanical stresses and operational conditions.

In a further embodiment, the female member 204 is detachably disposed on the first surface 102 and the male member 202 is removably received into the receptacle 108. Such a configuration allows easy assembly and disassembly of the connector device 200, improving convenience associated with straightforward installation and removal thereof. For example, the detachable female member 204 and the removable male member 202 enable quick replacement or adjustment of components in a maintenance scenario, thus reducing downtime and enhancing reusability. Consequently, the detachability and removability minimize resource wastage and improves the overall efficiency of the connector device 200. Additionally, the detachability and removability enhance ease of use of the connector device 200, enabling quick reconfiguration or replacement and contributing to resource efficiency by allowing the connector device 200 to be reused in different applications.

In another embodiment, the male member 202 is spring-loaded. The spring-loading of the male member 202 enables automatic engagement and alignment of the male member with the female member 204, ensuring a consistent and reliable connection. For example, the spring-loaded male member 202 enables quick and accurate alignment with the female member 202 in an assembly line setup, thereby reducing manual adjustments and enhancing assembly efficiency. Such spring-loading of the male member 202 is important for frequent adjustments or when vibrations occur by acting as a built-in vibration dampener, ensuring that the connection between objects remains secure and stable.

In yet another embodiment, the spring-loaded male member 202 is biased towards the first surface 102. The biasing of the spring-loaded male member 202 reduces the effort required by a user to insert the male member 202 into the female member 204 and thus enables easier connection between the first object and the second object 300. For example, the biasing minimizes manual effort and speeds up connection in assembly operations where frequent connections are needed. Additionally, the reduced insertion force required to be exerted by the user ensures smoother operation and less wear on both the male member 202 and the female member 204 in automated systems (such as, systems for automatic installation of the connector device 200).

In still another embodiment, the female member 204 comprises a quick-release mechanism. The incorporation of the quick-release mechanism allows rapid and convenient disconnection, thereby improving operational efficiency of the connector device 200. For example, the quick-release mechanism enables swift detachment and reattachment in maintenance operations where components need to be frequently accessed or replaced, thus reducing downtime. Consequently, the quick-release mechanism is advantageous in dynamic environments that require frequent reconfiguration or maintenance.

In another embodiment, the male member 202 comprises a stopper component. The surface area of the stopper component is greater than the size of the receptacle 108. Such a stopper component can be implemented as an inherent part of the male member 202. For example, when the male member is implemented as a screw or a bolt, the stopper component is a head of the screw or the bolt, respectively. Such a difference in the surface area of the stopper component and the size of the receptacle 108 prevents inadvertent disengagement of the male member 202 from the receptacle 108, ensuring that the stopper component provides a secure and fail-safe connection. For example, in high-vibration environments or applications where accidental impacts might occur, the larger stopper component ensures that the male member 202 remains firmly engaged with the bracket member 100, thus maintaining connection stability.

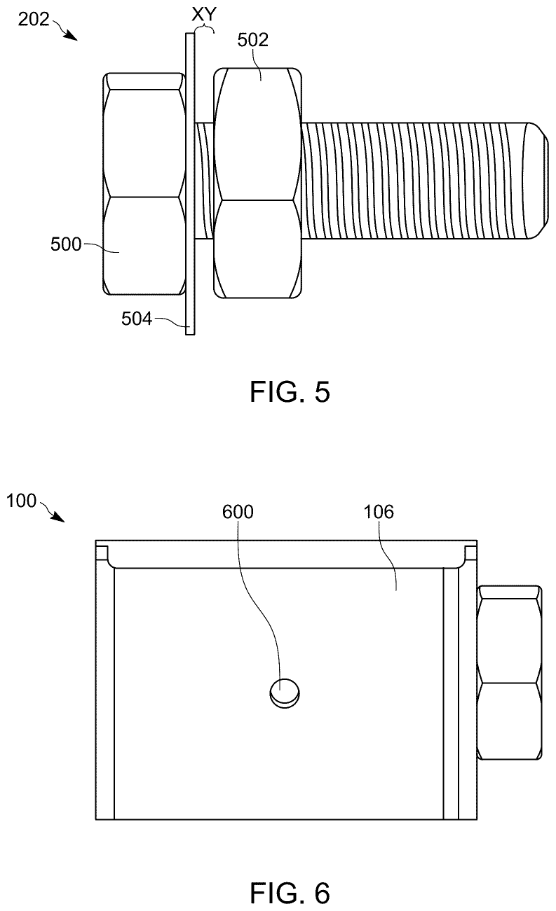

Referring to FIG. 5, there is shown a side view of the male member 202 (shown in FIG. 2), in accordance with an embodiment of the present disclosure. The male member 202 comprises a stopper component. As shown, the male member 202 is implemented as a double bolt. The double bolt comprises a bolt head 500. Further, the stopper component comprises a non-rotating nut 502. The non-rotating nut is a component that is received onto an elongate portion of the male member 202 and subsequently, permanently affixed to the male member 202, such as, through welding. Alternatively, the non-rotating nut 502 can be fabricated as an integral part of the male member 202. The stopper component further comprises a plate 504 disposed at a predefined separation XY from the non-rotating nut 502. Further, each of a first surface area of the non-rotating nut 502 and a second surface area of the plate 504 is more than the size of the receptacle 108. Such a male member 202 comprising the stopper component having the non-rotating nut 502 and the plate 504 enables to improved engagement of the male member 202 with the receptacle 108 as the non-rotating nut 502, the plate 504 and the bolt head 500 function as individual components as well as in conjunction with each other to prevent disengagement of the male member 202 from the receptacle 108.

Referring to FIG. 6, there is shown a top view of the bracket member 100 (shown in FIG. 1), in accordance with an embodiment of the present disclosure. As shown, the connecting surface 106 comprises an orifice 600.

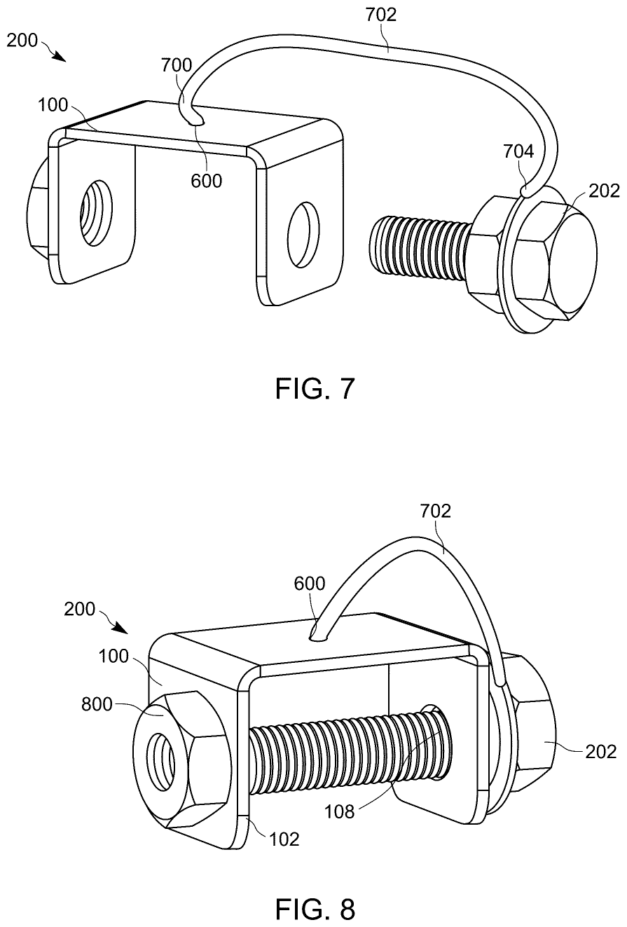

Referring to FIG. 7, there is shown a left-hand side perspective view of the connector device 200, in accordance with an embodiment of the present disclosure. As shown, the male member 202 comprises the stopper component having the bolt head 500, the non-rotating nut 502 and the plate 504. Further, the connecting surface 106 of the bracket member 100 comprises the orifice 600. As shown, the orifice 600 receives a first end 700 of a cable 702 therein and a second end 704 of the cable 702 is received in the separation XY between the non-rotating nut 502 and the plate 504. Such a simultaneous attachment of the cable 702 to each of the bracket member 100 and the male member 202 enables to secure the male member 202 with the bracket member 100, such as, when the male member 202 is removably connected to the bracket member 100. Consequently, the attachment of the male member 202 and the bracket member 100 via the cable enables to prevent misplacement of the male member 202, thereby, decreasing costs and operating time loss associated with replacement of the male member 202.

Referring to FIG. 8, there is shown a left-hand side perspective view of the connector device 200 (shown in FIG. 7), in accordance with an embodiment of the present disclosure. As shown, the male member 202 is completely passed through the receptacle 108 of the bracket member 100 and connected to a female member 800. As shown, the female member 800 is implemented as a nut is welded onto a rear side of the first surface 102. Such an implementation of the female member 800 as the nut welded onto the rear side of the first surface 102 enables to increase an area available between the first surface 102 and the second surface 104 for receiving the elongate portion of the male member 202 therethrough. Additionally, the nut welded onto the rear side of the first surface 102 can be employed to attach the connector device 200 to another component or surface, such as, by receiving a bolt into the nut, thereby, enabling to permanently or detachably secure the connector device 200 with component or surface.

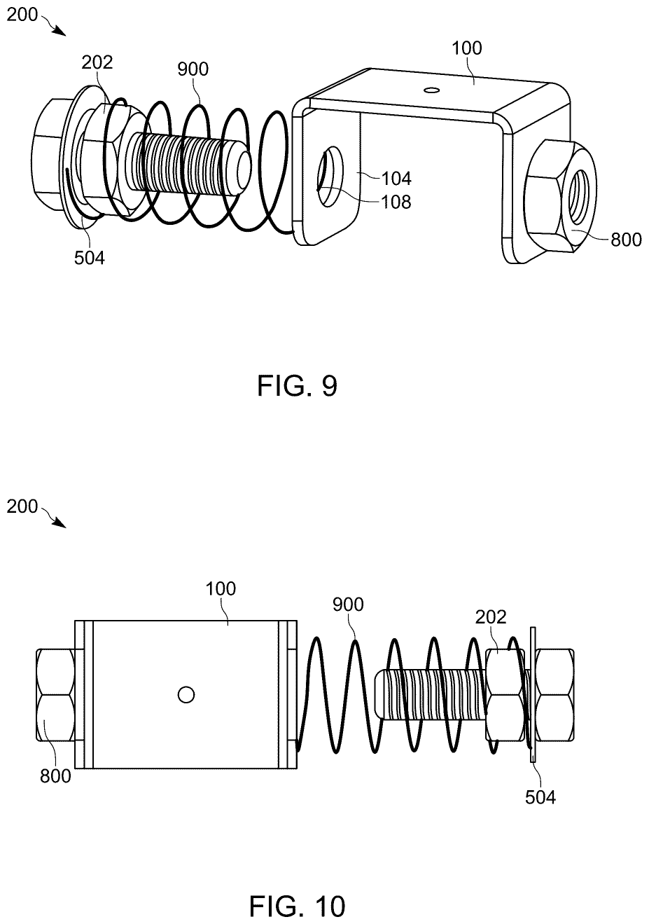

Referring to FIG. 9, there is shown a right-hand side perspective view of the connector device 200 (shown in FIG. 8), in accordance with an embodiment of the present disclosure. As shown, the connector device 200 comprises a helical spring 900 disposed between a rear side of the second surface 104 and the plate 504. The helical spring 900 is biased away from the rear side of the second surface 104. The helical spring 900 provides a biasing force that ensures that the male member 202 can be conveniently removed from the receptacle 108. For example, subsequent to uncoupling the male member 202 from the female member 204 during a detachable coupling condition of the male member 202 with the female member 204, the user is required to exert a negligible amount of force for moving the male member 202 back to a default position thereof, such that the default position of the male member 202 is associated with the rear side of the second surface 104. Thus, the arrangement of the helical spring 900 between the male member 202 and the rear side of the second surface 104 enables to improve operation of the connector device 200.

Referring to FIG. 10, there is shown a bottom-side view of the connector device 200 (shown in FIG. 9), in accordance with an embodiment of the present disclosure. As shown, in addition to reducing the amount of force required to be exerted for bringing the male member 202 back to the default position thereof, the connection of the male member 202 to the bracket member 100 via the helical spring 900 enables the connector device 200 to absorb mechanical shocks and vibrations that may occur during operation, thereby reducing wear on the connector device 200. Consequently, the inclusion of the helical spring 900 improves reliability and operational efficiency of the connector device 200, such as, in environments subject to dynamic forces or high-vibration conditions.

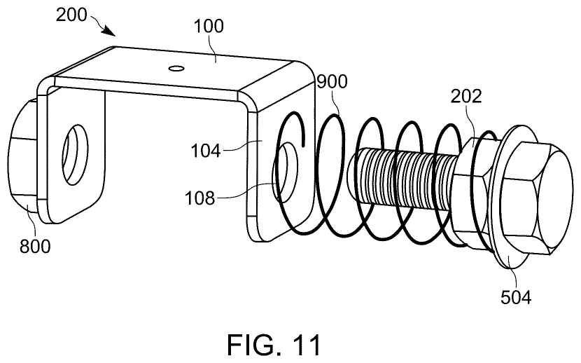

Referring to FIG. 11, there is shown a right-hand side perspective view of the connector device 200 (shown in FIGS. 9-10), in accordance with an embodiment of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

1. A connector device for connecting a first object and a second object, wherein the connector device is disposed on the first object and wherein the connector device comprises:
a bracket member comprising:
a first surface;
a second surface parallel to the first surface, wherein a receptacle is disposed on the second surface; and
a connecting surface connecting the first surface and the second surface;
a male member to be received through the receptacle; and
a female member disposed on the first surface;
wherein the male member is received through the receptacle, an opening in the second object and into the female member to connect the first object with the second object.

2. The connector device of claim 1, wherein the bracket member is a C-bracket, a D-bracket, a G-bracket, a H-bracket, or a U-bracket.

3. The connector device of claim 1, wherein the connecting surface is a curved surface or an angled surface comprising at least one bent portion.

4. The connector device of claim 1, wherein the female member is a nut, a hollow shaft comprising internal threads, a shaft collar, a hinge collar, a threaded split collar, a clamp, a U-clip, a spring-loaded shaft collar, a socket comprising internal threads, a clamping ring, a snap-fit receiver, or a detent mechanism receiver.

5. The connector device of claim 4, wherein the male member is a bolt, a screw, a shaft comprising external threads, a pin, a rod, a dowel, a snap-fit component to be received into the snap-fit receiver, or a detent pin to be received into the detent mechanism receiver.

6. The connector device of claim 1, wherein the female member is detachably disposed on the first surface and the male member is removably received into the receptacle.

7. The connector device of claim 1, wherein the male member is spring-loaded.

8. The connector device of claim 7, wherein the spring-loaded male member is biased towards the first surface.

9. The connector device of claim 1, wherein the female member comprises a quick-release mechanism.

10. The connector device of claim 1, wherein the male member comprises a stopper component and wherein a surface area of the stopper component is more than a size of the receptacle.

11. The connector device of claim 10, wherein the stopper component comprises:
a non-rotating nut; and
a plate disposed at a predefined separation from the non-rotating nut, wherein each of a first surface area of the non-rotating nut and a second surface area of the plate is more than the size of the receptacle.

12. The connector device of claim 11, wherein the connecting surface comprises an orifice for receiving a first end of a cable therein and wherein a second end of the cable is received in the separation between the non-rotating nut and the plate.

13. The connector device of claim 1, wherein a nut is welded onto a rear side of the first surface.

14. The connector device of claim 13, wherein a helical spring is disposed between a rear side of the second surface and the plate and wherein the helical spring is biased away from the rear side of the second surface.
